(19) United States
(12) Patent Application Publication
(10) Pub. No.: US 2026/0019893 A1
(43) Pub. Date: Jan. 15, 2026

(54) Methods for Inter-gNB Handover with L2 U2N Relay

(71) Applicant: Apple Inc., Cupertino, CA (US)

(72) Inventors: Zhibin WU, Los Altos, CA (US); Alexander SIROTKIN, Hod Hasharon (IL); Fangli XU, Beijing (CN); Haijing HU, Los Gatos, CA (US); Naveen Kumar R PALLE VENKATA, San Diego, CA (US); Pavan NUGGEHALLI, San Carlos, CA (US); Ralf ROSSBACH, Munich (DE); Sethuraman GURUMOORTHY, San Ramon, CA (US); Yuqin CHEN, Beijing (CN)

(21) Appl. No.: 18/881,953

(22) PCT Filed: Jul. 11, 2022
(86) PCT No.: PCT/CN2022/104992

§ 371 Date: Jan. 7, 2025

(51) Int. Cl. H04W 36/00; H04W 72/25; H04W 76/27

(52) U.S. Cl. CPC H04W 36/0072; H04W 72/25; H04W 76/27

(57) ABSTRACT

A base station is configured to receive a measurement report from a first user equipment (UE) including channel measurement results for a sidelink channel with at least a second UE available as a candidate relay UE for a layer 2 (L2) UE-to-network (U2N) relay, the measurement report further including a relay identifier and serving cell information for a serving cell of the second UE, select the second UE as a target relay UE for the first UE regardless of a current radio resource control (RRC) state of the second UE with the serving cell of the second UE and transmit a handover preparation message to the serving cell of the target relay UE, wherein the serving cell of the target relay UE is a target cell for handover of the first UE, the handover preparation message including the relay identifier of the target relay UE.

### TECHNICAL FIELD

This application relates generally to wireless communication, and in particular relates to methods for inter-gNB handover with L2 U2N relay.

### BACKGROUND INFORMATION

A user equipment (UE) may be configured with multiple communication links. For example, the UE may receive a signal from a cell of a corresponding network over a downlink and may transmit a signal to the cell of the corresponding network over an uplink. The UE may also be configured to communicate with a further UE via a sidelink (SL). The term sidelink refers to a communication link that may be utilized for device-to-device (D2D) communication.

The SL may be used for relay assistance to forward data/signals between a network and a remote UE that is out of range of the network and/or has poor network coverage. For example, a relay UE that is within range of the network and/or has good network coverage may relay data/signals between the network and the remote UE via the SL connection with the remote UE. A Layer 2 (L2) relay amplifies received signals to the destination after successful decoding/encoding and demodulation/modulation of the signals.

A typical, direct network connection (not employing the L2 relay) may be referred to as a direct network path for the UE, while the network connection employing the L2 relay over SL may be referred to as an indirect network path for the (remote) UE. According to current specification, path switching (e.g., handover) is supported from the indirect path to the direct path. However, inter-gNB path switching to a target indirect path is not currently supported.

### SUMMARY

Some exemplary embodiments are related to a processor of a base station configured to perform operations. The operations include receiving a measurement report from a first user equipment (UE) including channel measurement results for a sidelink channel with at least a second UE available as a candidate relay UE for a layer 2 (L2) UE-to-network (U2N) relay, the measurement report further including a relay identifier and serving cell information for a serving cell of the second UE, selecting the second UE as a target relay UE for the first UE regardless of a current radio resource control (RRC) state of the second UE with the serving cell of the second UE and transmitting a handover preparation message to the serving cell of the target relay UE, wherein the serving cell of the target relay UE is a target cell for handover of the first UE, the handover preparation message including the relay identifier of the target relay UE.

Other exemplary embodiments are related to a processor of a base station configured to perform operations. The operations include receiving a handover preparation message from a serving cell of a first user equipment (UE), wherein the serving cell of the first UE is a source cell for handover of the first UE, the handover preparation message including a relay identifier of a second UE available as a target relay UE for a layer 2 (L2) UE-to-network (U2N) relay under the base station, identifying a current radio resource control (RRC) state of the second UE and transmitting a handover preparation complete message to the source cell, the handover preparation complete message including an indication of whether the target relay UE is prepared for handover.

Still further exemplary embodiments are related to a processor of a base station configured to perform operations. The operations include comprising receiving a measurement report from a first user equipment (UE) including channel measurement results for a sidelink channel with at least a second UE available as a candidate relay UE for a layer 2 (L2) UE-to-network (U2N) relay, the measurement report further including a relay identifier and serving cell information for a serving cell of the second UE, transmitting a relay query request to the serving cell of the second UE, the relay query request including the relay identifier of the second UE and receiving a relay query response from the serving cell of the second UE, the relay query response including an indication of whether the second UE is in a first state comprising a radio resource control (RRC) CONNECTED state, a second state comprising an RRC IDLE or INACTIVE state, or a third state wherein the second UE is out of coverage of the serving cell.

### BRIEF DESCRIPTION OF THE DRAWINGS

FIG. 1a shows a first exemplary handover scenario (Scenario A) for a user equipment (UE) comprising inter-gNB indirect-to-direct path switching.

FIG. 1b shows a second exemplary handover scenario (Scenario B) for a UE comprising inter-gNB direct-to-indirect path switching.

FIG. 1c shows a third exemplary handover scenario (Scenario C) for a UE comprising intra-gNB indirect-to-indirect path switching.

FIG. 1d shows a fourth exemplary handover scenario (Scenario D) for a UE comprising inter-gNB indirect-to-indirect path switching.

FIG. 2a shows an exemplary signaling diagram for inter-gNB handover to an indirect target path wherein a target relay UE is in the RRC CONNECTED state according to a first option.

FIG. 2b shows an exemplary signaling diagram for inter-gNB handover to an indirect target path wherein the target relay UE is in the RRC IDLE or INACTIVE state according to the first option.

FIG. 3a shows an exemplary signaling diagram for inter-gNB handover to an indirect target path wherein a target relay UE is in the RRC CONNECTED state according to a second option.

FIG. 3b shows an exemplary signaling diagram for inter-gNB handover to an indirect target path wherein a target relay UE is out of coverage with respect to the target gNB according to the second option.

FIG. 3c shows an exemplary signaling diagram for inter-gNB handover to an indirect target path wherein a target relay UE is in the RRC IDLE or INACTIVE state according to the second option.

FIG. 4 shows an exemplary signaling diagram for inter-gNB handover to an indirect target path wherein a target relay UE is in the RRC CONNECTED state according to a third option.

FIG. 5 shows an exemplary network arrangement according to various exemplary embodiments.

FIG. 6 shows an exemplary UE according to various exemplary embodiments.

FIG. 7 shows an exemplary base station according to various exemplary embodiments.

FIG. 8 shows an arrangement for various protocol functions that may be implemented in a wireless communication device according to various exemplary embodiments.

FIG. 9 shows an exemplary network diagram comprising a base station, a relay UE and a remote UE.

### DETAILED DESCRIPTION

The exemplary embodiments may be further understood with reference to the following description and the related appended drawings, wherein like elements are provided with the same reference numerals. The exemplary embodiments relate to operations for inter-gNB path switching (e.g., handover) for a user equipment (UE) wherein the target path comprises a layer 2 (L2) UE-to-network (U2N) relay. In particular, the exemplary embodiments relate to procedures for a source gNB to select a target relay UE to provide an indirect network path between a target gNB and a remote UE after the handover is complete. Importantly, the radio resource control (RRC) state of one or more candidate target relay UEs under the target gNB can be provided to the source gNB and used by the source gNB to select a target relay and/or perform the handover. In some embodiments, the RRC state of the candidate UE(s) is provided to the source gNB prior to selecting one of the candidate UEs as the target relay. In other embodiments, the source gNB selects a candidate UE as the target relay regardless of the RRC state of the selected target relay. In these embodiments, the RRC state is received from the target gNB prior to the source gNB initiating the handover procedure.

The exemplary embodiments are described with regard to a UE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to a sidelink (SL). The term “sidelink” generally refers to a communication link between the UE and a further UE. The SL provides direct device-to-device (D2D) communication where information and/or data exchanged between the UE and the further UE via the sidelink does not go through a cell. In some configurations, a single SL provides bidirectional data communication between the UE and the further UE. In other configurations, a single SL provides unidirectional data communication between the UE and the further UE, although signaling may be transmitted in both directions. The term “unicast” refers to one-to-one, i.e., D2D, communication and generally may refer to either bidirectional or unidirectional communication. Various embodiments may apply to either one or both forms of communication as indicated below.

SL communications are supported by both Long-Term Evolution (LTE) and 5G new radio (NR) standards. In some configurations, the network may provide information to the UE that indicates how an SL is to be established, maintained and/or utilized. Thus, while the information and/or data exchanged over the SL does not go through a cell, the UE and the network may exchange information associated with the SL via the network cell. In other configurations, an SL is not under the control of the network. In either configuration, the first UE and the second UE may still perform synchronization procedures, discovery procedures and exchange control information corresponding to the SL.

The SL may be used for relay assistance to forward data/signals between a network and a remote UE that is out of range of the network and/or has poor network coverage. For example, a relay UE that is within range of the network and/or has good network coverage may relay data/signals between the network and the remote UE via the SL connection with the remote UE. A Layer 2 (L2) relay amplifies received signals to the destination after successful decoding/encoding and demodulation/modulation of the signals.

A typical network connection not employing the L2 relay may be referred to as a direct network path for the UE, while the L2 relay over SL may be referred to as an indirect network path for the (remote) UE. In Rel-17, path switching (e.g., handover) is supported from the indirect path to the direct path under the same gNB (intra-gNB handover).

In Rel-18, path switching will be supported for inter-gNB indirect-to-direct path switching, inter-gNB direct-to-indirect path switching, intra-gNB indirect-to-indirect path switching and inter-gNB indirect-to-indirect path switching.

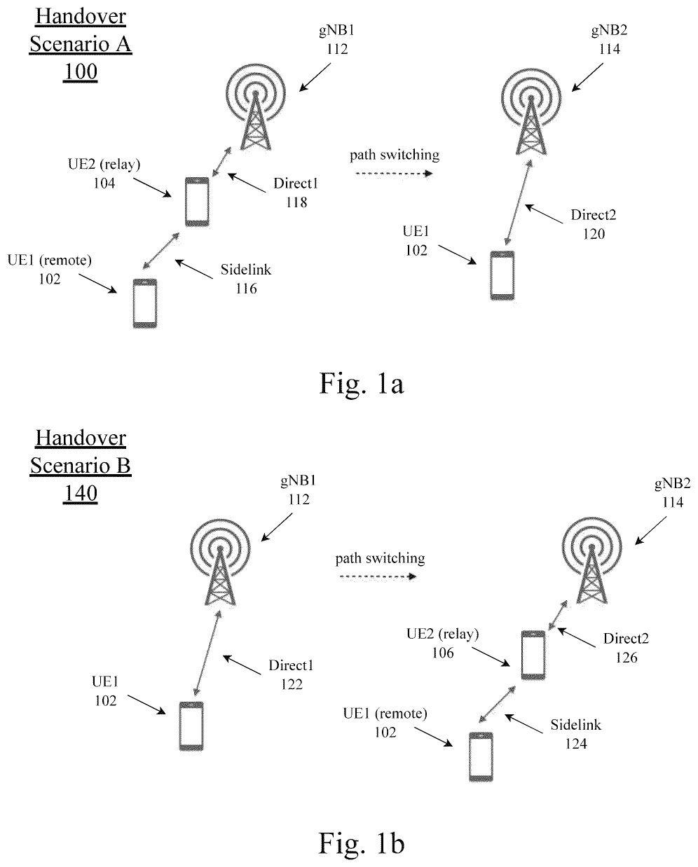

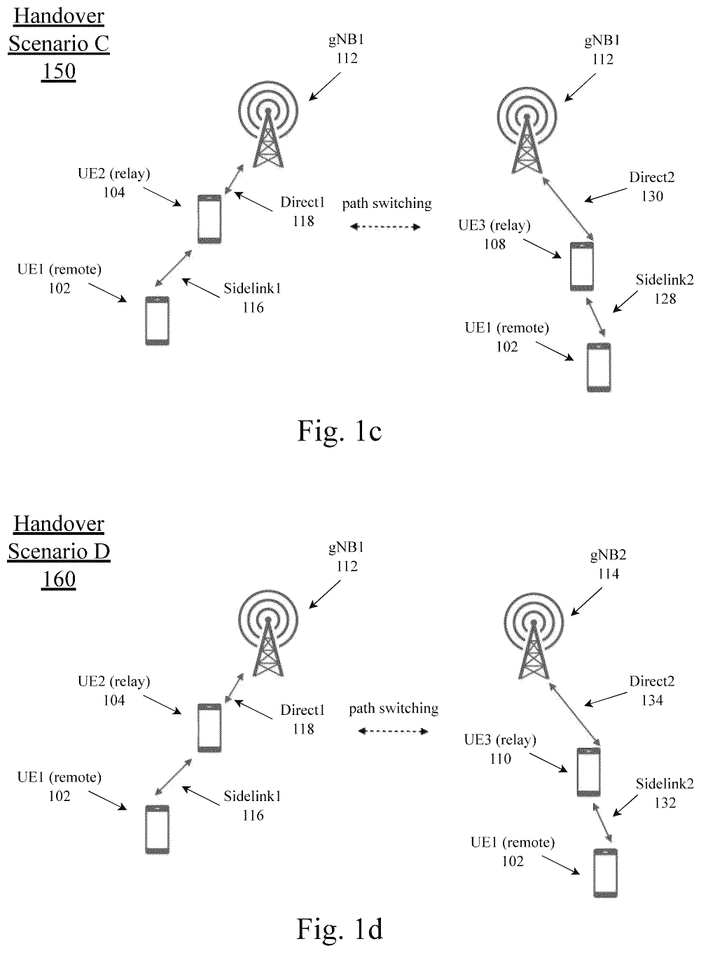

FIG. 1a shows a first exemplary handover scenario 100 (Scenario A) for a user equipment (UE) 102 comprising inter-gNB indirect-to-direct path switching. In the first scenario 100, the UE 102 (UE1) transitions from a first communications path (current path) with a first gNB 112 (gNB1), e.g., a source gNB, to a second communications path (target path) with a second gNB 114 (gNB2), e.g., a target gNB. The current path comprises an indirect path, e.g., an L2 relay, wherein a second UE 104 (UE2) serves as a relay UE for the remote UE1 102. The remote UE1 102 and the relay UE2 104 communicate over a sidelink (SL) 116, and the relay UE2 104 and the source gNB1 108 communicate over a first direct link 118 (Direct1). The target path comprises a direct path wherein the UE1 102 and the target gNB2 114 communicate over a second direct link 120 (Direct2).

FIG. 1b shows a second exemplary handover scenario 140 (Scenario B) for a UE 102 comprising inter-gNB direct-to-indirect path switching. In the second scenario 140, the UE 102 (UE1) transitions from a first communications path (current path) with a first gNB 112 (gNB1), e.g., a source gNB, to a second communications path (target path) with a second gNB 114 (gNB2), e.g., a target gNB. The current path comprises a direct path wherein the UE1 102 and the source gNB1 112 communicate over a first direct link 122 (Direct1). The target path comprises an indirect path, e.g., an L2 relay, wherein a second UE 106 (UE2) serves as a relay UE for the remote UE1 102. The remote UE1 102 and the relay UE2 106 communicate over a sidelink (SL) 124, and the relay UE2 106 and the target gNB2 114 communicate over a second direct link 126 (Direct2).

FIG. 1c shows a third exemplary handover scenario 150 (Scenario C) for a UE 102 comprising intra-gNB indirect-to-indirect path switching. In the third scenario 150, the UE 102 (UE1) transitions from a first communications path (current path) with a gNB 108 (gNB1) to a second communications path (target path) with the gNB1 112. Similar to the first scenario 100, the current path comprises a first indirect path, e.g., a first L2 relay, wherein a second UE 104 (UE2) serves as a relay UE for the remote UE1 102. The remote UE1 102 and the relay UE2 104 communicate over a first sidelink (SL) 116 (Sidelink1), and the remote UE2 104 and the gNB1 112 communicate over a first direct link 118 (Direct1). The target path comprises a second indirect path, e.g., a second L2 relay, wherein a third UE 108 (UE3) serves as a relay UE for the remote UE1 102. The remote UE1 102 and the relay UE3 106 communicate over a second sidelink (SL) 128 (Sidelink2), and the relay UE3 108 and the gNB1 112 communicate over a second direct link 130 (Direct2).

FIG. 1d shows a fourth exemplary handover scenario 160 (Scenario D) for a UE 102 comprising inter-gNB indirect-to-indirect path switching. In the fourth scenario 160, the UE 102 (UE1) transitions from a first communications path (current path) with a first gNB 112 (gNB1), e.g., a source gNB, to a second communications path (target path) with a second gNB 114 (gNB2), e.g., a target gNB. Similar to the first and third scenarios 100, 150, the current path comprises a first indirect path, e.g., a first L2 relay, wherein a second UE 104 (UE2) serves as a relay UE for the remote UE1 102. The remote UE1 102 and the relay UE2 104 communicate over a first sidelink (SL) 116 (Sidelink1), and the relay UE2 104 and the source gNB1 112 communicate over a first direct link 118 (Direct1). The target path comprises a second indirect path, e.g., a second L2 relay, wherein a third UE 110 (UE3) serves as a relay UE for the remote UE1 102. The remote UE1 102 and the relay UE3 110 communicate over a second sidelink (SL) 132 (Sidelink2), and the relay UE3 110 and the target gNB2 110 communicate over a second direct link 134 (Direct2).

With respect to the first handover scenario 100 (Scenario A—inter-gNB indirect-to-direct path switching), existing procedures may be suitable to support this case. For example, the remote UE, using a current communications path with the first gNB (gNB1), e.g., the source gNB, comprising an indirect path (L2 relay), can report neighbor cell measurements to the source gNB1 via the relay UE according to currently supported UE reporting procedures. Thus, the remote UE can report channel measurements for a second gNB (gNB2), e.g., a target gNB, to the source gNB1, and the source gNB1 can prepare the remote UE and the target gNB2 for UE handover to the target gNB2 comprising a direct target path.

In scenarios where the target path is an indirect path (Scenarios B, C and D), it may be preferable to select a UE to serve as the target relay UE when this UE is in the RRC CONNECTED state with the target gNB. For example, if a relay UE is selected that is in the RRC IDLE or INACTIVE states with the target gNB, the target gNB and the relay UE must establish a dedicated RRC connection (e.g., the relay UE must enter the CONNECTED state with the target gNB) before the relay UE can relay data/signals between the target gNB and the remote UE, as will be described in greater detail below. Thus, prior to initiating a path switch for the UE, it may be preferable for the source gNB to know whether the target relay UE is in the CONNECTED state or not.

With respect to the third handover scenario 150 (Scenario C—intra-gNB indirect-to-indirect path switching), where a single gNB is both the source and target gNB, the gNB has knowledge of the RRC state of the UEs that may be selected as the target relay UE. The gNB can select the target relay UE according to gNB implementation, and a different handover procedure can be executed depending on whether the target relay UE is in the CONNECTED state or the IDLE/INACTIVE state, to be described in greater detail below.

With respect to the second and fourth handover scenarios 140, 160 (Scenario B—inter-gNB direct-to-indirect path switching; Scenario D—inter-gNB indirect-to-indirect path switching), at least two gNBs are involved in the handover, e.g., the source gNB and the target gNB. The source gNB, making the path switching decisions, does not have direct knowledge of the RRC state of the UEs that may be selected as the target relay UE under the target gNB.

As mentioned above, the handover procedure to an indirect path depends on the RRC state of the target relay UE. According to Rel-17 procedures for intra-gNB path switching from the direct path to the indirect path (e.g., handover from a direct path under a gNB to an indirect path using a relay UE under the same gNB), the gNB and the remote UE can use a first connection setup procedure when the target relay UE is in the CONNECTED state and a second connection setup procedure when the target relay UE is in the IDLE/INACTIVE state.

In the first procedure, where the target relay UE is in the CONNECTED state, the gNB controls the handover operations and prepares the relay UE for the remote UE handover (e.g., a gNB-controlled approach). The gNB selects the relay UE and prepares the relay UE for handover in an RRC reconfiguration message including, e.g., P5 relay RLC channel information and a bearer mapping configuration for the SL communications with the remote UE. The gNB then transmits a handover command (RRC reconfiguration) to the remote UE including similar information (with respect to the relay UE) for the remote UE to establish the SL with the relay UE. The handover command includes the dedicated RLC channel configuration so that the UE can transmit a handover complete message (an RRC reconfiguration complete message) via the L2 U2N relay using the relay UE. The data path is then switched to the indirect path and the remote UE can send/receive further data/signaling on the indirect path.

In the second procedure, where the target relay UE is in the IDLE or INACTIVE state, the remote UE can trigger the relay UE to enter the CONNECTED state, (e.g., a UE-assisted approach). The gNB selects the relay UE and transmits a handover command to the remote UE without first preparing the relay UE for handover. In this procedure, the handover command does not include a dedicated RLC channel configuration for the UE to use, so the remote UE must use the default RLC channel configuration to establish a PC5 link with the relay UE. The remote UE then transmits the RRC reconfiguration complete message to the relay UE, which triggers the relay UE to enter the CONNECTED state and relay the reconfiguration complete message to the gNB. The gNB then reconfigures the CONNECTED relay UE to setup the indirect path, and the remote UE can send/receive further data/signaling on the indirect path via the relay UE.

Prior to performing the connection setup procedures described above, the source gNB considers which target relay UE to select for the UE handover to the indirect path. To provide the source gNB with candidate relay UEs, the remote UE can perform a discovery procedure. The discovery procedure can include transmitting a relay discovery message and monitoring the sidelink for relay discovery messages from candidate relay UEs. The discovery procedure can comprise the remote UE broadcasting a layer 2 (L2) U2N relay discovery query. Candidate UEs receiving the broadcast can transmit to the remote UE a L2 U2N relay discovery response including one or more reference signals (RS) that are measured by the remote UE to determine channel state information (CSI), e.g., RSRP, for the SL channels to be used in SL communications with the candidate UEs. The relay discovery response further includes serving cell information and the L2 ID of the candidate relay UE. In some scenarios, candidate target relay UEs can broadcast an L2 U2N relay announcement without first receiving a discovery query. The remote UE provides the channel measurements, serving cell information, and L2 ID of each candidate UE to the source gNB in a measurement report. The source gNB considers the candidate UEs included in the one or more measurement reports received from the remote UE to select the target relay UE. The target relay UE selection process is performed according to gNB implementation and can be performed in dependence on factors such as the RRC state of candidate relay UEs, the SL channel strength between the remote UE and the candidate relay UEs, and any other factors that may be based on implementation details or defined in standards.

In Rel-17, only intra-gNB direct-to-indirect path switching is supported. Thus, in these procedures, the serving gNB has direct knowledge of the RRC states of all candidate relay UEs because only the serving gNB is involved in the handover. However, returning to Scenario B (inter-gNB direct-to-indirect path switching) and Scenario D (inter-gNB indirect-to-indirect path switching), to be supported in Rel-18 as discussed above, at least two gNBs will be involved in the handover, e.g., the source gNB and the target gNB. The source gNB, making the path switching decisions, does not have direct knowledge of the RRC state of potential UEs that may be selected as the target relay UE (under the target gNB) because the RRC state information for these UEs is not included in the relay discovery message(s) received by the remote UE from the candidate UEs.

It is noted that the UE connected with the source gNB, prior to handover to the indirect path on the target gNB, is referred to herein as the “remote UE” even if the connection with the source gNB is a direct connection (e.g., as shown in handover Scenario B 140 of FIG. 1b). The term “remote” is in reference to the UE after handover, when the indirect path is established with the target gNB via the relay UE, and should not be construed to imply that the UE necessarily has an indirect path with the source gNB (e.g., as shown in handover Scenario 160 of FIG. 1d).

According to various exemplary embodiments described herein, multiple approaches can be considered for inter-gNB handover of a UE from a current path on a first (source) gNB to an indirect target path on a second (target) gNB. As described above, no procedure currently exists for providing the source gNB with RRC state information for candidate relay UEs served by the target gNB. Without the RRC state information of these candidate relay UEs, the source gNB cannot make a fully informed decision when selecting one of these candidate UEs as a target relay UE for the handover to the indirect path. Additionally, the source gNB cannot determine whether to initiate a gNB-controlled handover procedure or a UE-assisted handover procedure without first knowing the RRC state of the target relay UE.

In a first option, the source gNB can select a target relay UE for remote UE handover from one or more candidate UEs regardless of the current RRC state of the candidate UE(s). The source gNB can select the target relay UE based on gNB implementation in view of considerations including channel measurements for the candidate UEs provided by the remote UE in one or more measurement reports. However, once a target relay UE is selected, the source gNB must communicate with the target gNB to receive the RRC state information of the target relay UE. With the RRC state information, the source gNB knows whether the target relay UE is prepared for handover and trigger the appropriate handover procedure.

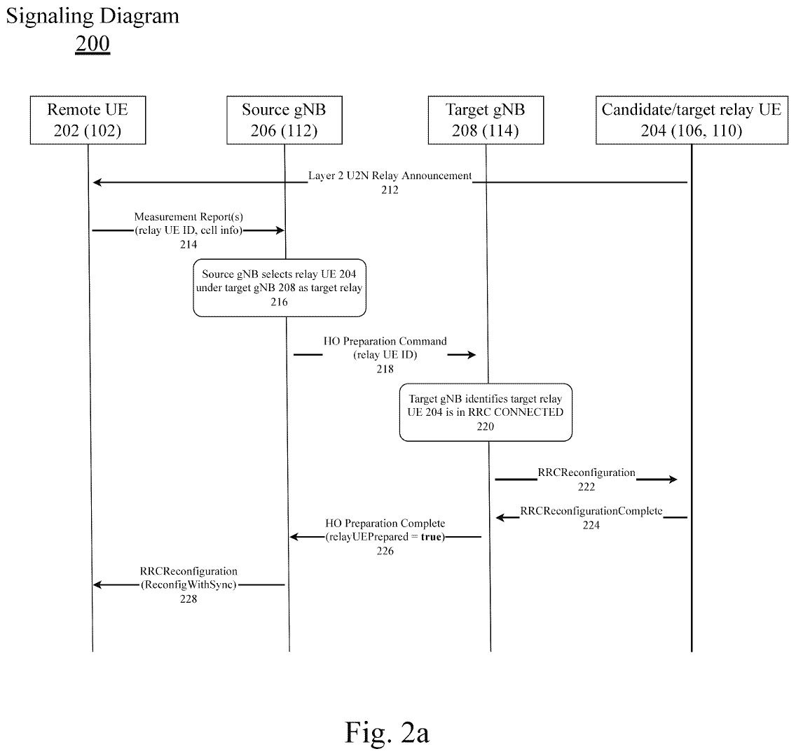

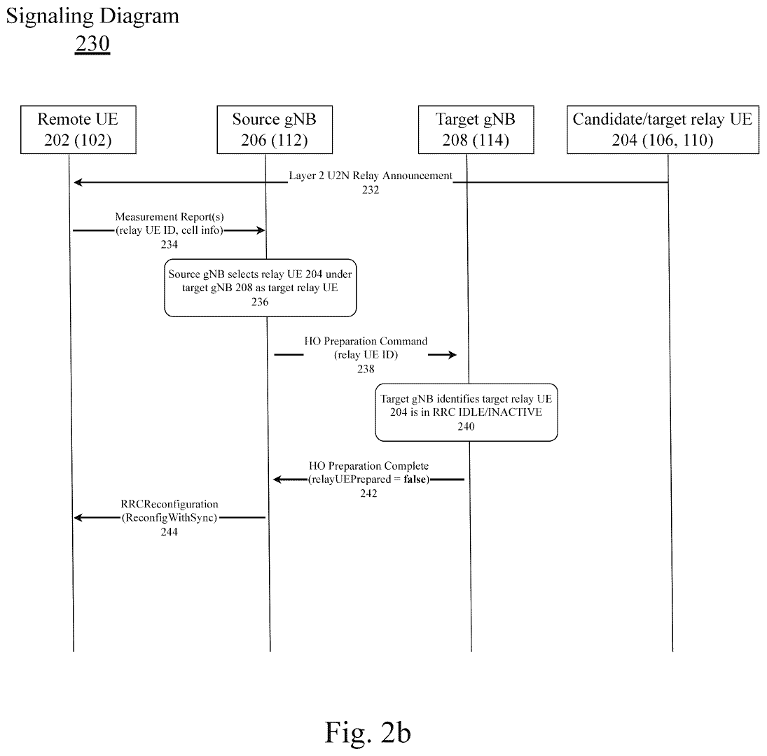

Regardless of the RRC state of the selected target relay UE, the source gNB can transmit a handover preparation message to the target gNB identifying the target relay UE. If the target relay UE is in the CONNECTED state, the target gNB can reconfigure the target relay UE for the L2 U2N relay and the source gNB can reconfigure the remote UE for the handover (e.g., in a gNB-controlled handover approach), as will be explained below in FIG. 2a. If the target relay UE is in the IDLE or INACTIVE state, the source gNB can configure the remote UE to set up the indirect path with the target relay UE from the UE side (e.g., UE-assisted approach), as will be explained below in FIG. 2b.

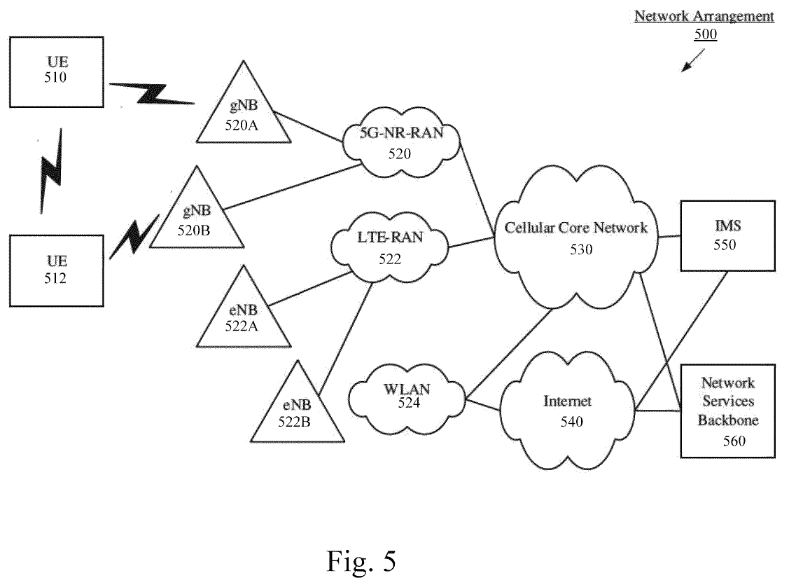

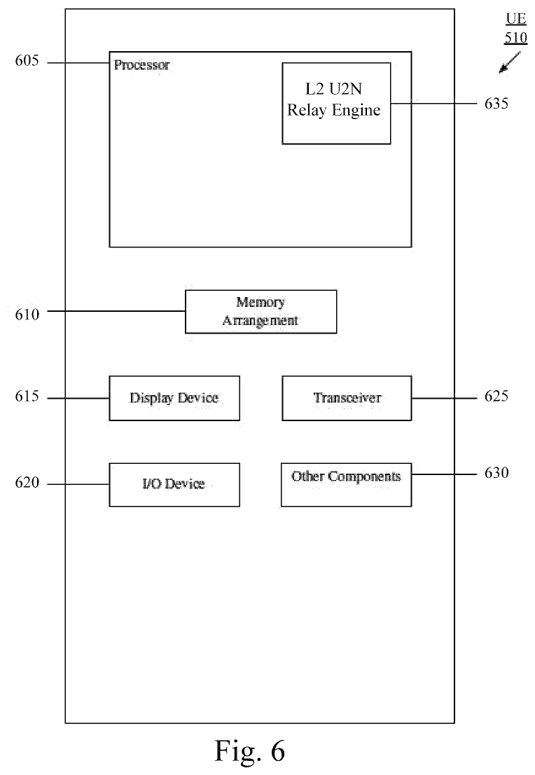

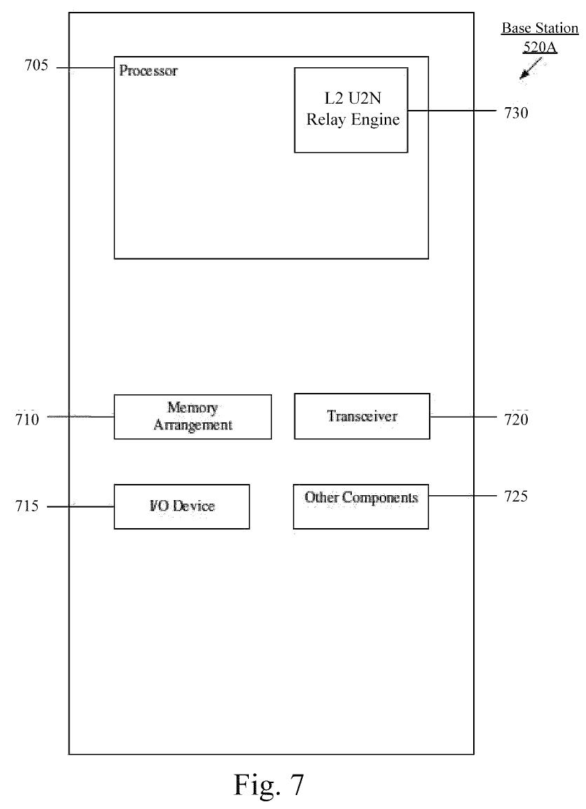

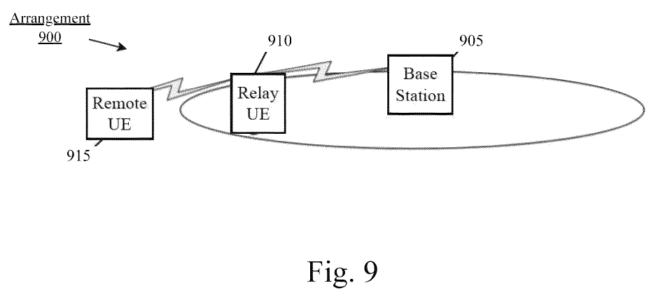

FIG. 2a shows an exemplary signaling diagram 200 for inter-gNB handover to an indirect target path wherein a target relay UE is in the RRC CONNECTED state according to a first option. In this example, the inter-gNB handover procedure includes a first (remote) UE 202 served by a first (source) gNB 206 handed over to an indirect target path comprising a sidelink with a second (target relay) UE 204 on a second (target) gNB 208 when the target relay UE 204 is in the RRC CONNECTED state. The remote UE 202 of the signaling diagram 200 may correspond to the UE1 102 described in FIGS. 1b, 1d; the UE 510 described below in FIG. 5 or 6; or the remote UE 915 described below in FIG. 9. The target relay UE 204 of the signaling diagram 200 may correspond to the UE2 106 described in FIG. 1b or the UE3 110 described in FIG. 1d; the UE 512 described below in FIG. 5 or the UE 510 described below in FIG. 6; or the relay UE 910 described below in FIG. 9. The source gNB 206 of the signaling diagram 200 may correspond to the gNB1 112 described in FIGS. 1b, 1d; or the gNB 520A described below in FIG. 5 or 7. The target gNB 208 of the signaling diagram 200 may correspond to the gNB2 114 described in FIGS. 1b, 1d; the gNB 520B described below in FIG. 5 or the gNB 520A described below in FIG. 7; or the base station 905 described below in FIG. 9.

In 212, the remote UE 202 receives a L2 U2N relay discovery message from the (candidate) target relay UE 204. The discovery message can be transmitted by the candidate UE 204 in response to a query from the remote UE 202 and/or in a relay announcement. The remote UE 202 can measure the channel quality and decode information from the candidate UE 204 including a relay UE ID and serving cell information (e.g., for the target gNB 208). It is noted that the remote UE 202 can receive and decode multiple L2 U2N relay discovery messages from multiple candidate target relay UEs.

In 214, the remote UE 202 transmits a measurement report including the relay UE ID and serving cell information in association with the channel measurement results for the (candidate) target relay UE 204. The remote UE 202 can transmit measurement results for one or multiple candidate target relay UEs in one or more measurement reports. The measurement report(s) can include measurements for candidate UEs under one or more serving cells. The source gNB 206 receives the one or more measurement reports for the one or more candidate UEs.

In 216, the source gNB 206 evaluates the measurement results of the one or more candidate target relay UEs, including the (candidate) target relay UE 204, and selects the relay UE 204 under the gNB 208 as the target relay UE 204. The source gNB 206 selects the relay UE 204 as the target relay regardless of the current RRC state of the relay UE 204. It is noted that further candidate UEs may be available for selection that are served by the source gNB 206. In this scenario, the source gNB 206 may have RRC state information for these further candidate UEs, and the selection of the relay UE 204 as the target relay may be informed by the RRC states of the further candidate UEs under the source gNB 206.

In 218, the source gNB 206 transmits a handover preparation message to the gNB 208 as the target gNB 208 serving the target relay UE 204. The handover preparation message includes the relay UE ID of the target relay UE 204. Additionally, the handover preparation message includes the Layer-2 address of the remote UE 202 and a corresponding local identifier of the remote UE 202 to be used in SRAP (Sidelink Relay Adaptation Protocol). In some embodiments, the source gNB 206 can generate this local identifier so that it can be uniquely identified by the network among all the remote UEs associated with a layer 2 UE-to-network relay UE.

In 220, the target gNB 208 identifies the current RRC state of the target relay UE 204. In the example of signaling diagram 200, the target relay UE 204 is in the RRC CONNECTED state.

In 222, the target gNB 208 prepares the target relay UE 204 for handover. The handover preparation includes an RRC reconfiguration message including remote UE 202 information (such as the L2 address) and relay path parameters, e.g., parameters for the target relay UE 204 to establish the L2 U2N relay with the remote UE 202.

In 224, the target gNB 208 receives an RRC reconfiguration complete message indicating that the target relay UE 204 is prepared for the handover.

In 226, the target gNB 208 transmits a handover preparation complete message to the source gNB 206 indicating that the target relay UE 204 is prepared for handover. The source gNB 206 receives the handover preparation complete message and determines that the target relay UE 204 is in the RRC CONNECTED state. Thus, the gNB-controlled handover procedure can be used for the remote UE 202.

In 228, the source gNB 206 transmits a handover command (RRC reconfiguration) to the remote UE 202 including parameters for the remote UE to establish the SL with the relay UE, including the dedicated RLC channel configuration for the UE to transmit a handover complete message (an RRC reconfiguration complete message) via the L2 U2N relay using the relay UE, as described above. The handover command further includes parameters for the remote UE 202 to synchronize with the target gNB 208. The data path is then switched to the indirect path and the remote UE can send/receive further data/signaling on the indirect path.

FIG. 2b shows an exemplary signaling diagram 230 for inter-gNB handover to an indirect target path wherein the target relay UE is in the RRC IDLE or INACTIVE state according to the first option. Similar to the signaling diagram 200 of FIG. 2a, the inter-gNB handover procedure includes a first (remote) UE 202 served by a first (source) gNB 206 handed over to an indirect target path comprising a sidelink with a second (target relay) UE 204 on a second (target) gNB 208. Similar to the signaling diagram 200 of FIG. 2a, the remote UE 202 may correspond to the UE1 102; the target relay UE 204 may correspond to the UE2 106 or the UE3 110; the source gNB 206 may correspond to the gNB1 112; and the target gNB 208 may correspond to the gNB2 114.

Steps 232-240 may be performed similarly to corresponding steps 212-220 of FIG. 2a. However, in the example of signaling diagram 230, in step 240, the target gNB 208 identifies the current RRC state of the target relay UE 204 as the RRC IDLE or INACTIVE state. Thus, in this example, the target gNB 208 cannot reconfigure the target relay UE 208 for the handover until the target relay UE 208 enters the RRC CONNECTED state.

In 242, the target gNB 208 transmits a handover preparation complete message to the source gNB 206 indicating that the target relay UE 204 is not prepared for handover. The source gNB 206 receives the handover preparation complete message and determines that the target relay UE 204 is not in the RRC CONNECTED state. Thus, the UE-assisted handover procedure can be used for the remote UE 202.

In 244, the source gNB 206 transmits a handover command (RRC reconfiguration) to the remote UE 202. Because the target relay UE 204 is not prepared for handover, the handover command to the remote UE 202 does not include a dedicated RLC channel configuration for the remote UE 202 to use for SL communications with the target relay UE 204. Thus, the remote UE 202 uses the default RLC channel configuration to establish a PC5 link with the relay UE 204 and transmit the RRC reconfiguration complete message to the relay UE 204. In this UE-assisted handover procedure, the target relay UE 204 is not aware that it has been chosen as the relay UE for the remote UE 202 as it is unprepared. The receipt of the RRC reconfiguration complete message from the remote UE 202 triggers the relay UE 204 to enter the CONNECTED state and relay the reconfiguration complete message to the target gNB 208. After the relay UE 204 is triggered by the PC5 link establishment procedure to enter the RRC CONNECTED state, the relay UE 204 will be prepared for handover. The gNB 208 then reconfigures the CONNECTED relay UE 204 to setup the indirect path. The remote UE can send/receive further data/signaling on the indirect path via the relay UE.

As described above, according to the first exemplary option, the gNB selects a target relay UE without prior knowledge of whether the selected relay UE is already in the CONNECTED state with the target gNB. It is possible that the selection of the target relay UE is bad and will result in handover failure. For example, the target relay UE may no longer be camped in the cell of the target gNB. In another example, the latency of a handover to the IDLE or INACTIVE target relay UE may be too large, and the source gNB may prefer a CONNECTED target relay UE so that the handover latency is smaller.

Accordingly, it may be preferred for the source gNB to know whether the one or more candidate target relay UE(s) are in the CONNECTED state. This information may be acquired by the source gNB according to the second, third, and/or fourth options described below.

In the second option, the source gNB can query one or more target gNB(s) for RRC state information of one or more candidate target relay UEs before selecting a target relay UE for remote UE handover. Thus, the source gNB can evaluate the candidate relay UEs in view of the RRC state information for the candidate UEs to determine a preferred candidate UE to select as the target relay UE.

According to the second option, the target gNB(s) can identify one of three states for the candidate target relay UE(s) identified in the query. A first state for the candidate target relay UE is the RRC CONNECTED state; a second state for the candidate target relay UE is the RRC IDLE/INACTIVE state; a third state for the candidate target relay UE is an out of coverage state, wherein the candidate UE is no longer in the cell of the target gNB, e.g., has been handed over to another cell.

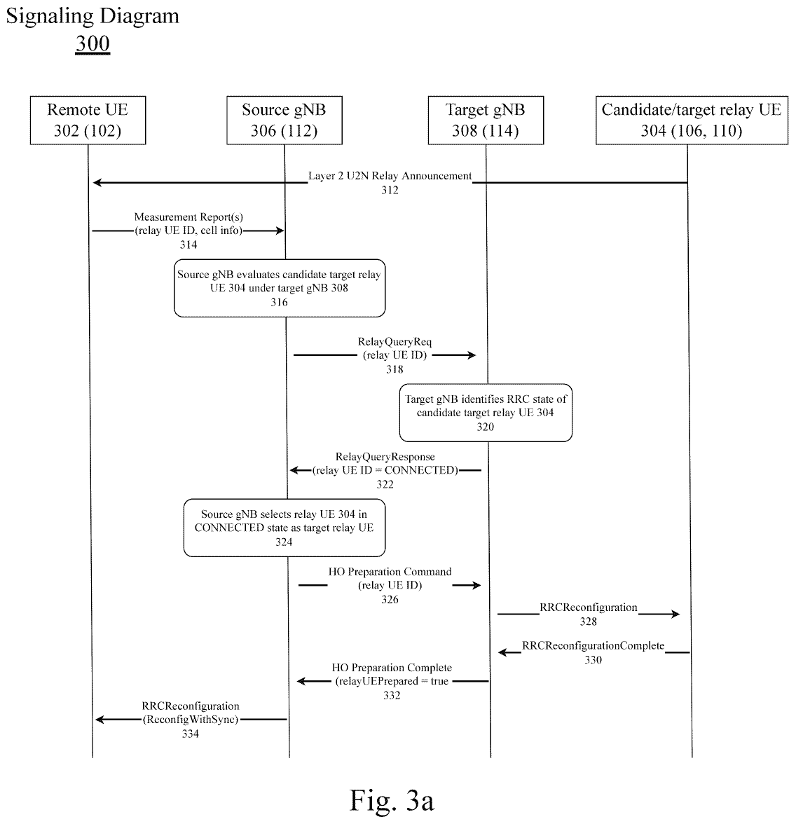

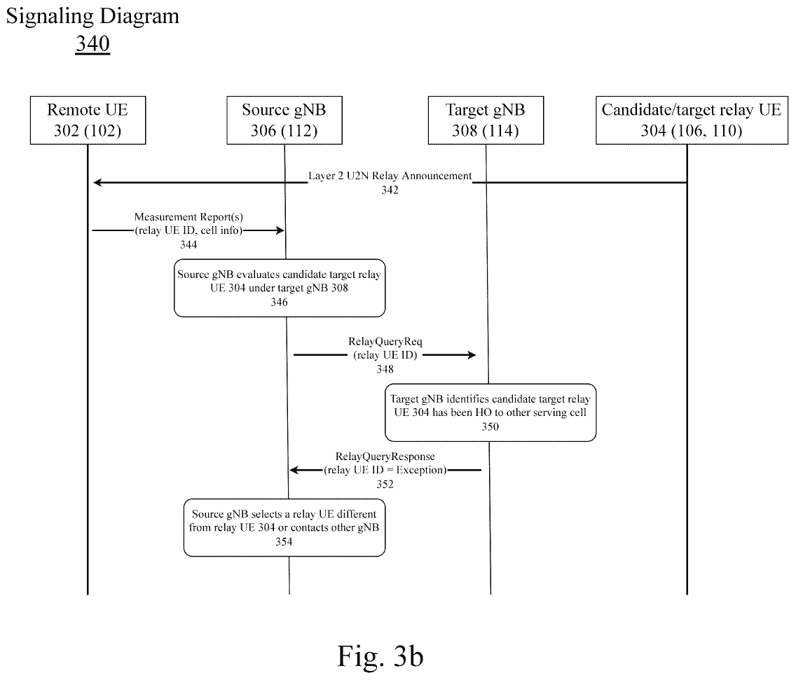

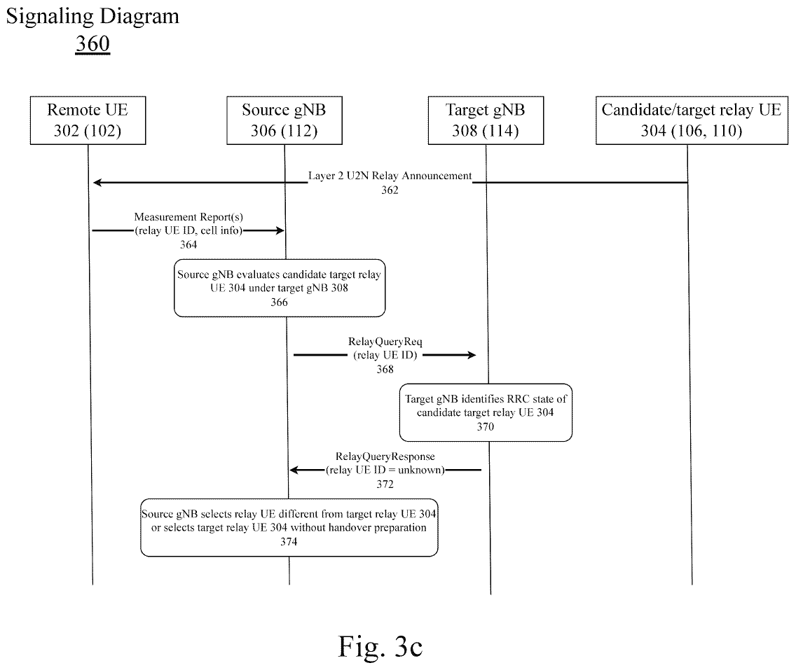

The target gNB can transmit a response to the relay query including an indication of whether the identified target relay UE(s) is in the CONNECTED state (Connected), not in the CONNECTED state (unknown), or no longer in its cell (Exception). The source gNB can receive the response and, in consideration of the knowledge of the current state of one or more candidate target relay UEs, can perform further operations for handover of the remote UE to the indirect path, as will be described in detail below in FIGS. 3a-c.

FIG. 3a shows an exemplary signaling diagram 300 for inter-gNB handover to an indirect target path wherein a target relay UE is in the RRC CONNECTED state according to a second option. Similar to the signaling diagram 200 of FIG. 2a, the inter-gNB handover procedure includes a first (remote) UE 302 served by a first (source) gNB 306 handed over to an indirect target path comprising a sidelink with a second (target relay) UE 304 on a second (target) gNB 308 when the target relay UE 304 is in the RRC CONNECTED state. Similar to the signaling diagrams 200 and 230 of FIGS. 2a-b, the remote UE 302 may correspond to the UE1 102; the target relay UE 304 may correspond to the UE2 106 or the UE3 110; the source gNB 306 may correspond to the gNB1 112; and the target gNB 308 may correspond to the gNB2 114.

Steps 312-314 may be performed similarly to corresponding steps 212-214 of FIG. 2a. The remote UE 302 receives at least one L2 U2N relay discovery message from at least one (candidate) target relay UE, including the candidate target relay UE 304. Similar to above, the remote UE 302 can receive and decode multiple L2 U2N relay discovery messages from multiple candidate target relay UEs. The remote UE 302 transmits a measurement report including the relay UE ID and serving cell information in association with the channel measurement results for the one or multiple candidate UEs including the candidate UE 304. The measurement report(s) can include measurements for candidate UEs under one or more serving cells. The source gNB 306 receives the one or more measurement reports for the one or more candidate UEs.

In 316, the source gNB 306 evaluates the measurement results of the one or more candidate target relay UEs, including the (candidate) target relay UE 304, and identifies one or more candidate target relay UEs having a presently unknown RRC state. For example, the source gNB 306 may seek to acquire the current RRC state of all or a subset of the candidate UEs under one or more serving cells.

In 318, the source gNB 306 transmits a relay query request to one or more serving gNBs of one or more candidate target relay UEs, including the (candidate) target gNB 308 of the (candidate) target relay 304. For example, in 316, the source gNB 306 may determine that multiple different candidate target relay UEs are suitable for handover of the remote UE 302 based on the measurement results for these candidate UEs. Thus, the source gNB 306 may transmit a relay query request to multiple cells, including the target gNB 308 serving the candidate target relay UE 304 that is selected in 324, to be described in further detail below.

In 320, the (candidate) target gNB 308 identifies the current state of the (candidate) target relay UE 304. As described, the current state of the candidate UE 304 can be the RRC CONNECTED state, the RRC IDLE or INACTIVE state, or out of coverage. In the example of signaling diagram 300, the target relay UE 304 is in the RRC CONNECTED state.

In 322, the (candidate) target gNB 308 transmits a relay query response to the source gNB 306 indicating that the target relay UE 304 is in the RRC CONNECTED state. The source gNB 306 receives the response message. It is noted that, in this option, the reception of the message indicating the CONNECTED state for the candidate UE 304 does not automatically trigger the selection of the candidate UE 304 as the target relay UE 304. Based on responses received from one or more (candidate) target gNBs concerning one or more (candidate) target relay UEs, if a more suitable candidate UE is also known to be in the CONNECTED state, the source gNB 302 is free to select this other candidate relay UE.

In 324, the source gNB 306 selects the candidate target relay UE 304 under the gNB 308 as the target relay UE.

Steps 326-334 may be performed similarly to corresponding steps 218, 222-228 of FIG. 2a. The source gNB 306 transmits a handover preparation message to the gNB 308 as the target gNB 308 serving the target relay UE 304. The target gNB 308 prepares the target relay UE 204 for handover, including transmitting an RRC reconfiguration and receiving an RRC reconfiguration complete message. The target gNB 308 transmits a handover preparation complete message to the source gNB 306 indicating that the target relay UE 304 is prepared for handover. Thus, the gNB-controlled handover procedure can be used for the remote UE 302, and the source gNB 306 transmits a handover command (RRC reconfiguration) to the remote UE 302 including parameters for the remote UE 302 to establish the SL with the relay UE, including the dedicated RLC channel configuration for the UE to transmit a handover complete message (an RRC reconfiguration complete message) via the L2 U2N relay using the relay UE, as described above. The data path is then switched to the indirect path and the remote UE can send/receive further data/signaling on the indirect path.

FIG. 3b shows an exemplary signaling diagram 340 for inter-gNB handover to an indirect target path wherein a target relay UE is out of coverage with respect to the target gNB according to the second option. Similar to the signaling diagram 300 of FIG. 3a, the inter-gNB handover procedure includes a first (remote) UE 302 served by a first (source) gNB 306 and a second (target relay) UE 304. However, in this example, the target relay UE 304 is no longer served by a second (target) gNB 308. For example, the target relay UE 304 may have been handed over to another cell.

Steps 342-350 may be performed similarly to corresponding steps 312-320 of FIG. 3a. As described, the current state of the candidate UE 304 can be the RRC CONNECTED state, the RRC IDLE or INACTIVE state, or out of coverage. In the example of signaling diagram 340, in step 350, the target gNB 308 determines the target relay UE 304 is out of coverage.

In 352, the (candidate) target gNB 308 transmits a relay query response to the source gNB 306 indicating that the candidate target relay UE 304 is out of coverage (relay UE ID=Exception). The source gNB 306 receives the response message.

In 354, the source gNB 306 performs further handover actions in dependence on the knowledge that the candidate UE 304 is out of coverage range of the candidate target gNB 308. For example, the source gNB 306 can either select a candidate target relay UE different from the candidate UE 304 or contact a different gNB that is currently serving the candidate UE 304.

FIG. 3c shows an exemplary signaling diagram 360 for inter-gNB handover to an indirect target path wherein a target relay UE is in the RRC IDLE or INACTIVE state according to the second option. Similar to the signaling diagram 300 of FIG. 3a, the inter-gNB handover procedure includes a first (remote) UE 302 served by a first (source) gNB 306 and a second (target relay) UE 304 served by a second (target) gNB 308. However, in this example, the candidate target relay UE 304 is in the RRC IDLE or INACTIVE state under the target gNB 308.

Steps 362-370 may be performed similarly to corresponding steps 312-320 of FIG. 3a or steps 342-350 of FIG. 3b. As described, the current state of the candidate UE 304 can be the RRC CONNECTED state, the RRC IDLE or INACTIVE state, or out of coverage. In the example of signaling diagram 360, in step 370, the target gNB 308 determines the target relay UE 304 is in the RRC IDLE/INACTIVE state.

In 372, the (candidate) target gNB 308 transmits a relay query response to the source gNB 306 indicating that the candidate target relay UE 304 is in the RRC IDLE/INACTIVE state (relay UE ID=unknown). The source gNB 306 receives the response message.

In 374, the source gNB 306 performs further handover actions in dependence on the knowledge that the candidate UE 304 is in the RRC IDLE/INACTIVE state under the candidate target gNB 308. For example, the source gNB 306 can either select a candidate target relay UE different from the candidate UE 304 or select the candidate UE 304 as the target relay UE without handover preparation. If the candidate UE 304 is selected, the UE-assisted handover procedure can be initiated by the source gNB 306.

As shown above, the second option described in FIGS. 3a-c uses a query/response procedure to provide the source gNB with knowledge of the RRC state of candidate target relay UEs. However, in the option to be described below, this information can be provided proactively prior to the initiation of any handover processes.

In the third option, neighboring gNBs can proactively exchange relay UE information including the current RRC state of relay UE(s) served by the respective gNBs. Thus, the source gNB can evaluate the candidate relay UEs in view of the RRC state information for the candidate UEs to determine a preferred candidate UE to select as the target relay UE. This may be done proactively by having each gNB announce the RRC_CONNECTED Layer 2 UE-to-NW relay UEs to its neighbor gNBs. In this way, each gNB is able to maintain a list of “CONNECTED” relays in its own cell and neighboring cells.

These information exchanges for relay UEs may occur frequently or infrequently. For example, if the gNBs transmit this information infrequently, this option can be used in combination with either of the first or second options discussed above. If the source gNB making the handover decision determines that information for relay UEs received from a given neighbor gNB is stale or outdated, then the source gNB may implement the first or second option described above.

In another example, if the gNBs transmit this information frequently, the source gNB can consider the relay UE information as current and make the handover decision in dependence thereon. However, this approach may involve significantly more signaling overhead.

As described above, according to the second and third exemplary options, neighboring gNBs may exchange a relatively high number of messages to provide current RRC state information for relay UEs. Accordingly, it may be preferred to use an approach that reduces the messaging overhead while still providing the RRC state information to the source gNB prior to the target relay selection stage of the handover process.

In the fourth option, the remote UE can acquire the RRC state of candidate target relay UEs directly from the respective candidate UEs. The candidate relay UEs can provide the RRC information in a relay discovery response message, and the remote UE can include the RRC state in a measurement report to a source gNB in association with the relay UE ID and serving cell information.

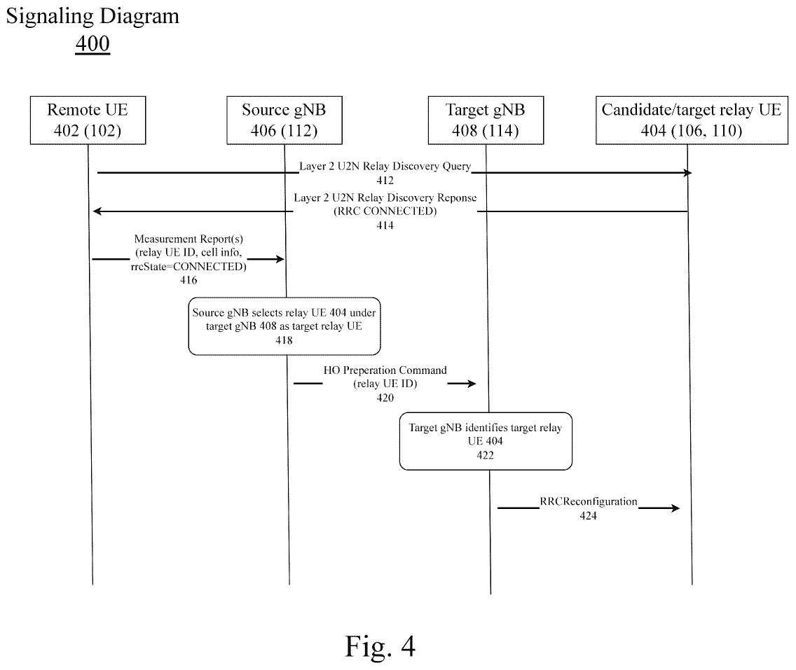

FIG. 4 shows an exemplary signaling diagram 400 for inter-gNB handover to an indirect target path wherein a target relay UE is in the RRC CONNECTED state according to a third option. Similar to the signaling diagram 200 of FIG. 2a, the inter-gNB handover procedure includes a first (remote) UE 402 served by a first (source) gNB 406 handed over to an indirect target path comprising a sidelink with a second (target relay) UE 404 on a second (target) gNB 408 when the target relay UE 404 is in the RRC CONNECTED state. Similar to the signaling diagrams 200 and 230 of FIGS. 2a-b, the remote UE 402 may correspond to the UE1 102; the target relay UE 404 may correspond to the UE2 106 or the UE3 110; the source gNB 406 may correspond to the gNB1 112; and the target gNB 408 may correspond to the gNB2 114.

In 412, the remote UE 402 transmits a relay discovery query. The query can include a request for a current RRC state from responding relay UEs, or the inclusion of this information can be automatically triggered when the query is received. The relay discovery query is received by the candidate target relay UE 404.

In 414, the candidate target relay UE 404 transmits a relay discover response to the remote UE 402 including an indication of the current RRC state of the candidate UE 404. In this example, the response includes an indication that the candidate target relay UE 404 is in the RRC CONNECTED state under its serving cell, e.g., candidate target gNB 408.

In 416, the remote UE 402 transmits a measurement report to the source gNB 406 including the relay UE ID, serving cell information, and current RRC state in association with the channel measurement results for the (candidate) target relay UE 404. Similar to above, one or multiple measurement reports for one or multiple candidate target relay UEs can be transmitted.

Steps 418-420 can be performed similarly to steps 324-326 of FIG. 3a. The source gNB 402 selects the candidate UE 404 as the target relay UE and transmits a handover preparation command to the target gNB 408 including the relay UE ID of the target relay UE 404. In 422, the target gNB 408 identifies the target relay UE 404. In 424, the target gNB 408 reconfigures the target relay UE 404 for handover.

FIG. 5 shows an exemplary network arrangement 500 according to various exemplary embodiments. The exemplary network arrangement 500 include UEs 510, 512. Those skilled in the art will understand that the UEs 510, 512 may be any type of electronic component that is configured to communicate via a network, e.g., mobile phones, tablet computers, desktop computers, smartphones, phablets, embedded devices, wearables (e.g., HMD, AR glasses, etc.), Internet of Things (IoT) devices, etc. It should also be understood that an actual network arrangement may include any number of UEs being used by any number of users. Thus, the example of two UEs 510, 512 is merely provided for illustrative purposes.

The UEs 510, 512 may communicate directly with one or more networks. In the example of the network configuration 500, the networks with which the UEs 510, 512 may wirelessly communicate are a 5G NR radio access network (5G NR-RAN) 520, an LTE radio access network (LTE-RAN) 522 and a wireless local access network (WLAN) 524. These types of networks support sidelink (SL) communication. In the exemplary network arrangement 500, the UEs 510 and 512 may be connected via a SL. However, the UEs 510, 512 may also communicate with other types of networks and the UEs 510, 512 may also communicate with networks over a wired connection. Therefore, the UEs 510, 512 may include a 5G NR chipset to communicate with the 5G NR-RAN 520, an LTE chipset to communicate with the LTE-RAN 522 and an ISM chipset to communicate with the WLAN 524.

The 5G NR-RAN 520 and the LTE-RAN 522 may be portions of cellular networks that may be deployed by a network carrier (e.g., Verizon, AT&T, T-Mobile, etc.). These networks 520, 522 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 524 may include any type of wireless local area network (WiFi, Hot Spot, IEEE 802.11x networks, etc.).

The UEs 510, 512 may connect to the 5G NR-RAN via the gNB 520A or the gNB 520B. Reference to two gNBs 520A, 520B is merely for illustrative purposes. The exemplary embodiments may apply to any appropriate number of gNBs. The UEs 510, 512 may also connect to the LTE-RAN 522 via the eNBs 522A, 522B. Those skilled in the art will understand that any association procedure may be performed for the UEs 510, 512 to connect to the 5G NR-RAN 520 and the LTE-RAN 522. For example, as discussed above, the 5G NR-RAN 520 and the LTE-RAN 522 may be associated with a particular cellular provider where the UEs 510, 512 and/or the user thereof has a contract and credential information (e.g., stored on a SIM card). Upon detecting the presence of the 5G NR-RAN 520, the UEs 510, 512 may transmit the corresponding credential information to associate with the 5G NR-RAN 520. More specifically, the UEs 510, 512 may associate with a specific base station (e.g., the gNB 520A of the 5G NR-RAN 520, the eNB 522A of the LTE-RAN 522).

The UEs 510, 512 may also communicate with one another directly using a SL. The SL is a direct device-to-device (D2D) communication link. Thus, the information and/or data transmitted directly to the other endpoint (e.g., the UE 510 or the UE 512) does not go through a cell (e.g., gNB 520A, eNB 522A). In some embodiments the UEs 510, 512 may receive information from a cell regarding how the SL is to be established, maintained and/or utilized. Thus, a network (e.g., the 5G NR-RAN 520, LTE-RAN 522) may control the SL. In other embodiments, the UEs 510, 512 may control the SL. Regardless of how the SL is controlled, the UEs 510, 512 may maintain a downlink/uplink to a currently camped cell (e.g., gNB 520A, eNB 522A) and a SL to the other UE simultaneously.

In some scenarios, a UE, e.g., the UE 510, may not have a direct connection with a cell and may use a further UE, e.g., the UE 512, as a relay UE to forward data/signals to/from the UE 510 and/or the 5G NR-RAN 520. The SL may be used for relay assistance to forward data/signals between the 5G NR-RAN 520 and the remote UE 510 that is out of range of the network and/or has poor network coverage. A Layer 2 (L2) UE to network (U2N) relay amplifies received signals to the destination after successful decoding/encoding and demodulation/modulation of the signals.

In addition to the networks 520, 522 and 524 the network arrangement 500 also includes a cellular core network 530, the Internet 540, an IP Multimedia Subsystem (IMS) 550, and a network services backbone 560. The cellular core network 530 may be considered to be the interconnected set of components that manages the operation and traffic of the cellular network. The cellular core network 530 also manages the traffic that flows between the cellular network and the Internet 540. The IMS 550 may be generally described as an architecture for delivering multimedia services to the UEs 510, 512 using the IP protocol. The IMS 550 may communicate with the cellular core network 530 and the Internet 540 to provide the multimedia services to the UEs 510, 512. The network services backbone 560 is in communication either directly or indirectly with the Internet 540 and the cellular core network 530. The network services backbone 560 may be generally described as a set of components (e.g., servers, network storage arrangements, etc.) that implement a suite of services that may be used to extend the functionalities of the UEs 510, 512 in communication with the various networks.

FIG. 6 shows an exemplary UE 510 according to various exemplary embodiments. The UE 510 will be described with regard to the network arrangement 500 of FIG. 5. The UE 510 may also represent any of the UEs 102-110 described above with respect to FIGS. 1-4. The UE 510 may include a processor 605, a memory arrangement 610, a display device 615, an input/output (I/O) device 620, a transceiver 625 and other components 630. The other components 630 may include, for example, an audio input device, an audio output device, a power supply, a data acquisition device, ports to electrically connect the UE 510 to other electronic devices, etc.

The processor 605 may be configured to execute a plurality of engines of the UE 510. For example, the engines may include an L2 U2N relay engine 635 for performing various operations related to handover procedures to an indirect path, as described above.

The above referenced engine 635 being an application (e.g., a program) executed by the processor 605 is provided merely for illustrative purposes. The functionality associated with the engine 635 may also be represented as a separate incorporated component of the UE 510 or may be a modular component coupled to the UE 510, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 605 is split among two or more processors such as a baseband processor and an applications processor. The exemplary embodiments may be implemented in any of these or other configurations of a UE.

The memory arrangement 610 may be a hardware component configured to store data related to operations performed by the UE 510. The display device 615 may be a hardware component configured to show data to a user while the I/O device 620 may be a hardware component that enables the user to enter inputs. The display device 615 and the I/O device 620 may be separate components or integrated together such as a touchscreen. The transceiver 625 may be a hardware component configured to establish a connection with the 5G NR-RAN 520 and/or any other appropriate type of network. Accordingly, the transceiver 625 may operate on a variety of different frequencies or channels (e.g., set of consecutive frequencies).

FIG. 7 shows an exemplary base station 520A according to various exemplary embodiments. The base station 520A will be described with regard to the network arrangement 500 of FIG. 5. The base station 520A may represent any access node through which the UE 510 may establish a connection and manage network operations. The base station 520A may also represent the base station 520B of FIG. 5 or the gNBs 112, 114 described above with respect to FIGS. 1-4.

The base station 520A may include a processor 705, a memory arrangement 710, an input/output (I/O) device 715, a transceiver 720, and other components 725. The other components 725 may include, for example, a battery, a data acquisition device, ports to electrically connect the base station 700 to other electronic devices, etc.

The processor 705 may be configured to execute a plurality of engines of the base station 520A. For example, the engines may include an L2 U2N relay engine 730 for performing various operations related to handover procedures to an indirect path, as described above.

The above noted engine 730 being an application (e.g., a program) executed by the processor 705 is only exemplary. The functionality associated with the engine 730 may also be represented as a separate incorporated component of the base station 700 or may be a modular component coupled to the base station 700, e.g., an integrated circuit with or without firmware. For example, the integrated circuit may include input circuitry to receive signals and processing circuitry to process the signals and other information. In addition, in some base stations, the functionality described for the processor 705 is split among a plurality of processors (e.g., a baseband processor, an applications processor, etc.). The exemplary embodiments may be implemented in any of these or other configurations of a base station.

The memory 710 may be a hardware component configured to store data related to operations performed by the base station 700. The I/O device 715 may be a hardware component or ports that enable a user to interact with the base station 700. The transceiver 720 may be a hardware component configured to exchange data with the UE 510 and any other UE in the system 500. The transceiver 720 may operate on a variety of different frequencies or channels (e.g., set of consecutive frequencies). Therefore, the transceiver 720 may include one or more components (e.g., radios) to enable the data exchange with the various networks and UEs.

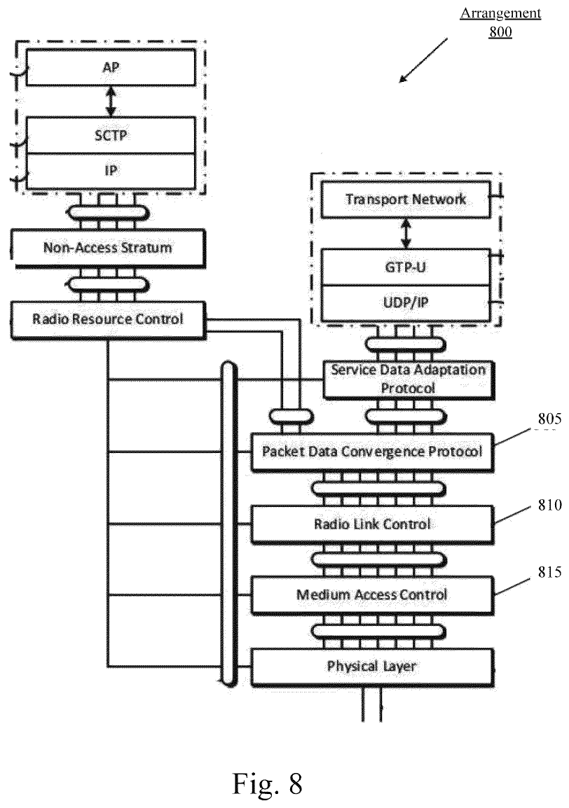

FIG. 8 shows an arrangement 800 for various protocol functions that may be implemented in a wireless communication device according to various exemplary embodiments. In particular, FIG. 8 shows instances of a MAC layer 805, an RLC layer 810 and a PDCP layer 815, which may be referred to collectively as Layer 2 (L2) of the protocol stack.

Instance(s) of MAC 805 may process requests from, and provide indications to, an instance of RLC 810 via one or more MAC service access points (SAPs). These requests and indications communicated via the MAC-SAP may comprise one or more logical channels. The MAC 805 may perform mapping between the logical channels and transport channels, multiplexing of MAC service data units (SDUs) from one or more logical channels onto transport blocks (TBs) to be delivered to PHY via the transport channels, de-multiplexing MAC SDUs to one or more logical channels from TBs delivered from the PHY via transport channels, multiplexing MAC SDUs onto TBs, scheduling information reporting, error correction through HARQ, and logical channel prioritization.

Instance(s) of RLC 810 may process requests from and provide indications to an instance of PDCP 815 via one or more radio link control service access points (RLC-SAP). These requests and indications communicated via RLC-SAP may comprise one or more RLC channels. The RLC 810 may operate in a plurality of modes of operation, including: Transparent Mode (TM), Unacknowledged Mode (UM), and Acknowledged Mode (AM). The RLC 810 may execute transfer of upper layer protocol data units (PDUs), error correction through automatic repeat request (ARQ) for AM data transfers, and concatenation, segmentation and reassembly of RLC SDUs for UM and AM data transfers. The RLC 810 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

Instance(s) of PDCP 815 may process requests from and provide indications to instance(s) of RRC and/or instance(s) of SDAP via one or more packet data convergence protocol service access points (PDCP-SAP). These requests and indications communicated via PDCP-SAP may comprise one or more radio bearers. The PDCP 815 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

A layer 2 (L2) user equipment to network (U2N) relay enables a remote device, e.g., a wearable device such as a watch, to access a cellular network via a relay device, e.g., a wireless phone. FIG. 9 shows an exemplary network diagram 900 comprising a base station 905, a relay UE 910 and a remote UE 915. The relay UE 910 is shown as being within the coverage area of the base station 905 and is able to exchange signaling/data with the base station 905, while the remote UE 915 is shown as being out-of-service of the base station 905. However, in some exemplary embodiments described herein, the remote UE 915 may be within the coverage area of the base station 905 and exchange signaling/data therewith. The relay UE 910 and the remote UE 915 may be connected via a SL configured by the network as an L2 relay.

For both user plane and control plane protocol architectures, relaying is performed above the RLC sublayer. The Uu interface for PDCP and RRC are terminated between the remote UE and the gNB while the RLC, MAC and PHY, and the non-3GPP transport layers, are terminated in each link (remote UE to relay UE, and relay UE to network).

### Examples

In a first example, a processor of a base station is configured to perform operations comprising receiving a relay query request from a serving cell of a first user equipment (UE), wherein the serving cell of the first UE is a source cell for handover of the first UE, the relay query request including a relay identifier of a second UE indicated as a target relay UE for a layer 2 (L2) UE-to-network (U2N) relay under the base station, identifying whether the second UE is in a first state comprising a radio resource control (RRC) CONNECTED state, a second state comprising an RRC IDLE or INACTIVE state, or a third state wherein the second UE is out of coverage of the base station and transmitting a relay query response to the serving cell of the first UE, the relay query response including an indication of whether the second UE is in the first state, the second state, or the third state.

In a second example, the processor of the first example, wherein the relay query response indicates the second UE is in the RRC CONNECTED state under the serving cell.

In a third example, the processor of the second example, wherein the operations further comprise receiving a handover preparation message from the serving cell of the source UE, the handover preparation message including the relay identifier of the second UE.

In a fourth example, the processor of the first example, wherein the relay query response indicates the second UE is in the RRC IDLE or INACTIVE state under the serving cell.

In a fifth example, the processor of the first example, wherein the relay query response indicates the second UE is out of coverage of the serving cell.

In a sixth example, the processor of the first example, wherein the operations further comprise periodically transmitting information for relay UEs in the RRC CONNECTED state under the base station to neighboring base stations.

In a seventh example, the processor of the first example, wherein the operations further comprise periodically receiving information for relay UEs in the RRC CONNECTED state under the base station from neighboring base stations.

In an eighth example, a processor of a user equipment (UE) is configured to perform operations comprising transmitting a layer 2 (L2) UE-to-network (U2N) relay discovery query, receiving a L2 U2N discovery response from a further UE available as a target relay UE for a L2 U2N relay under a target serving cell, the discovery response comprising a first indication of a current radio resource control (RRC) state of the further UE under the target serving cell and transmitting a measurement report to a serving cell including channel measurement results for a sidelink channel with the further UE and a second indication of the current RRC state of the further UE under the target serving cell.

In a ninth example, a processor of a base station is configured to perform operations comprising receiving a measurement report from a first user equipment (UE) including channel measurement results for a sidelink channel with at least a second UE available as a candidate relay UE for a layer 2 (L2) UE-to-network (U2N) relay, the measurement report further including a relay identifier and serving cell information for a serving cell of the second UE, the measurement report further including a current radio resource control (RRC) state of the second UE with the serving cell of the second UE, selecting the second UE as a target relay UE for the first UE in dependence on the current RRC state and transmitting a handover preparation message to the target serving cell of the target relay UE, wherein the serving cell of the target relay UE is a target cell for handover of the first UE, the handover preparation message including the relay identifier of the second UE.

In a tenth example, a processor of a base station is configured to perform operations comprising receiving a measurement report from a first user equipment (UE) including channel measurement results for a sidelink channel with at least a second UE available as a candidate relay UE for a layer 2 (L2) UE-to-network (U2N) relay, the measurement report further including a relay identifier and serving cell information for a serving cell of the second UE, periodically receiving information from one or more neighboring base stations indicating relay UEs in a radio resource control (RRC) CONNECTED state under the one or more neighboring base stations, determining, from the received information, that the second UE is in the RRC CONNECTED state under one of the neighboring base stations and selecting the second UE as a target relay UE for the first UE based on the second UE being in the RRC CONNECTED state.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. A processor of a base station configured to perform operations comprising:
receiving a measurement report from a first user equipment (UE) including channel measurement results for a sidelink channel with at least a second UE available as a candidate relay UE for a layer 2 (L2) UE-to-network (U2N) relay, the measurement report further including a relay identifier and serving cell information for a serving cell of the second UE;
selecting the second UE as a target relay UE for the first UE regardless of a current radio resource control (RRC) state of the second UE with the serving cell of the second UE; and
transmitting a handover preparation message to the serving cell of the target relay UE, wherein the serving cell of the target relay UE is a target cell for handover of the first UE, the handover preparation message including the relay identifier of the target relay UE.

2. The processor of claim 1, wherein the handover preparation message further includes a Layer-2 address of the first UE and a corresponding local identifier of the first UE to be used in Sidelink Relay Adaptation Protocol (SRAP).

3. The processor of claim 1, wherein the operations further comprise:
receiving a handover preparation complete message from the target cell, the handover preparation complete message including an indication of whether the target relay UE is prepared for handover.

4. The processor of claim 3, wherein the handover preparation complete message indicates the target relay UE is prepared for handover when the RRC state of the target relay UE is a RRC CONNECTED state and the target cell reconfigures the target relay UE to act as the L2 U2N relay with the first UE.

5. The processor of claim 4, wherein the operations further comprise:
transmitting a handover command to the first UE including parameters for establishing a sidelink with the target relay UE to establish an indirect path to the target gNB.

6. The processor of claim 4, wherein the parameters include a dedicated radio link control (RLC) channel configuration for the first UE to transmit a handover complete message to the target gNB via the target relay UE.

7. The processor of claim 3, wherein the handover preparation complete message indicates the target relay UE is not prepared for handover when the RRC state of the target relay UE is a RRC IDLE or INACTIVE state and the target cell does not reconfigure the target relay UE for the L2 U2N relay with the remote UE.

8. The processor of claim 7, wherein the operations further comprise:
transmitting a handover command to the first UE including parameters for establishing a sidelink with the target relay UE,
wherein the parameters include do not include a dedicated radio link control (RLC) channel configuration and the first UE uses a default RLC channel configuration to transmit a handover complete message to the target gNB via the target relay UE and trigger the target relay UE to enter the CONNECTED state.

9. A processor of a base station configured to perform operations comprising:
receiving a handover preparation message from a serving cell of a first user equipment (UE), wherein the serving cell of the first UE is a source cell for handover of the first UE, the handover preparation message including a relay identifier of a second UE available as a target relay UE for a layer 2 (L2) UE-to-network (U2N) relay under the base station;
identifying a current radio resource control (RRC) state of the second UE; and
transmitting a handover preparation complete message to the source cell, the handover preparation complete message including an indication of whether the target relay UE is prepared for handover.

10. The processor of claim 9, wherein the operations further comprise:
when the target relay UE is in a RRC CONNECTED state, transmitting an RRC reconfiguration to the target relay UE for the L2 U2N relay with the first UE; and
receiving an RRC reconfiguration complete message from the target relay UE.

11. The processor of claim 9, wherein the handover preparation complete message transmitted to the source cell indicates the target relay UE is prepared for handover.

12. The processor of claim 9, wherein, when the target relay UE is in a RRC IDLE or INACTIVE state, the handover preparation complete message transmitted to the source cell indicates the target relay UE is not prepared for handover.

13. A processor of a base station configured to perform operations comprising:
receiving a measurement report from a first user equipment (UE) including channel measurement results for a sidelink channel with at least a second UE available as a candidate relay UE for a layer 2 (L2) UE-to-network (U2N) relay, the measurement report further including a relay identifier and serving cell information for a serving cell of the second UE;
transmitting a relay query request to the serving cell of the second UE, the relay query request including the relay identifier of the second UE; and
receiving a relay query response from the serving cell of the second UE, the relay query response including an indication of whether the second UE is in a first state comprising a radio resource control (RRC) CONNECTED state, a second state comprising an RRC IDLE or INACTIVE state, or a third state wherein the second UE is out of coverage of the serving cell.

14. The processor of claim 13, wherein the relay query response indicates the second UE is in the RRC CONNECTED state under the serving cell.

15. The processor of claim 14, wherein the operations further comprise:
selecting the second UE as a target relay UE for the first UE based on the second UE being in the RRC CONNECTED state; and
transmitting a handover preparation message to the serving cell of the target relay UE, wherein the serving cell of the target relay UE is a target cell for handover of the first UE, the handover preparation message including the relay identifier of the second UE, a Layer-2 address of the first UE, and a corresponding local identifier of the first UE to be used in Sidelink Relay Adaptation Protocol (SRAP).

16. The processor of claim 13, wherein the relay query response indicates the second UE is in the RRC IDLE or INACTIVE state under the serving cell.

17. The processor of claim 16, wherein the operations further comprise:
selecting a further UE different from the second UE as a target relay UE for the first UE based on the second UE being in the RRC IDLE or INACTIVE state.

18. The processor of claim 16, wherein the operations further comprise:
selecting the second UE as a target relay UE for the first UE and implementing a UE-assisted handover procedure.

19. The processor of claim 13, wherein the relay query response indicates the second UE is out of coverage of the serving cell.

20-21. (canceled)

22. The processor of claim 13, wherein the operations further comprise:
periodically transmitting information for relay UEs in the RRC CONNECTED state under the base station to neighboring base stations; or.
periodically receiving information for relay UEs in the RRC CONNECTED state under the base station from neighboring base stations.

23. (canceled)
